(19) United States
(12) Patent Application Publication
(10) Pub. No.: US 2024/0119464 A1
(43) Pub. Date: Apr. 11, 2024

(54) SYSTEM FOR MANAGING DECOMMISSIONED FOSSIL FUEL RESOURCES

(71) Applicant: ZeroSix, LLC, Houston, TX (US)

(72) Inventors: Maarten Dekker, Houston, TX (US); Scot Innes Fraser, Houston, TX (US); Humberto David Sirvent, Fulshear, TX (US); Ondrej Sestak, Houston, TX (US); Arno Franciscus Hubertus Josephus Laeven, Bloemendaal (NL); Ioannis Vlachos, Athens (GR)

(21) Appl. No.: 18/377,961

(22) Filed: Oct. 9, 2023

Related U.S. Application Data
(60) Provisional application No. 63/414,190, filed on Oct. 7, 2022.

(51) Int. Cl. G06Q 30/018; E21B 47/117; G06Q 10/0631; G06Q 10/10; G06Q 40/04; G06Q 50/02

(52) U.S. Cl. CPC G06Q 30/018; E21B 47/117; G06Q 10/06316; G06Q 10/103; G06Q 40/04; G06Q 50/02; G06Q 2220/00

(57) ABSTRACT

A system is configured to provide guided interfaces and support for users throughout the process of abandoning an oil or gas well, and to create and issue carbon credits corresponding to the abandonment upon completion of the project. The system architecture is configured to ensure that carbon credits issued from the system are transparent and auditable, and that underlying support for the credits is accurate and supports the additionality and permanence of the project. Project information and documentation is stored on a public blockchain and distributed file system to ensure immutability and availability of the records. Carbon credits from a completed project are issued as tokens or other digital assets that may be exchanged between parties, and retired for reporting and emission offset purposes. Each token minted by the system links back to a specific project on the blockchain, allowing for public review of all supporting information and documentation.

The present application claims priority to U.S. Provisional Application Ser. No. 63/414,190 filed Oct. 7, 2022, which is incorporated herein by reference.

### FIELD OF DISCLOSURE

The disclosed technology pertains to a system for managing and tracking oil wells, gas wells, and other fossil fuel wells or natural resource sites from the beginning of the process of decommissioning the well to the end of the process of decommissioning the well. A system is configured to provide guided interfaces and support for users throughout the process of abandoning an oil or gas well, and to create and issue carbon credits corresponding to the abandonment upon completion of the project.

### BACKGROUND OF THE DISCLOSURE

There is a need for increased production in high quality carbon credits in order for the United States and other countries to reach a goal of net-zero emissions and mitigate the effects of climate change. A carbon credit is a generic term for any tradable certificate or permit representing the offsetting or reduction of greenhouse gas emissions. In some instances, one carbon credit may be recognized as equal to the emission compensation of one metric ton of CO2 or an equivalent Greenhouse Gas, hence the notation of tCO2e or tCO2 eq. Besides abated CO2 emissions, carbon credits typically generate broader environmental, social and economic benefits, namely increased biodiversity, clean air, support of local communities, and other positive impacts collectively referred to herein as “co-benefits”. For any government, business or individual looking to achieve net-zero emissions the adagio should be “avoid, reduce, then compensate”. As a result, activities related to and driven by carbon credits may facilitate the last mile to net-zero CO2 emissions.

Currently, the generation or issuance of carbon credits is largely confined to a handful of small markets and producers that possess the legal and regulatory sophistication and support to navigate the complex processes required to produce a carbon credit. Meanwhile, the average person or small business has no meaningful ability to participate in the production of carbon credits. Even where a small business owner or land owner's current or future activities might qualify for the production of carbon credits, the cost and difficulty of navigating the complex process makes it unreasonable to do so. There are also a number of technical challenges in registering, managing, and tracking such activities in order to ensure that any related credits are high quality, reliable, and documented, and such challenges are not addressed by conventional technologies or approaches.

As a result of the above limitations and technical challenges, a significant amount of beneficial activity is not recognized or rewarded, and there is also a significant amount of potential beneficial activity that may never occur because the party in question sees no recognition or reward in undertaking it. What is needed, therefore, is an improved system for managing and tracking abandonment of fossil fuel and other natural resources while producing high quality and reliable documentation and support for carbon credits and other offsets.

### SUMMARY OF DISCLOSURE

The present disclosure relates to a system and method for managing and tracking of fossil fuel and other natural resources from the beginning of the process of decommissioning the well for fossil fuels and other natural resources to the end of the process of decommissioning the well for fossil fuels and other natural resources while producing high quality and reliable documentation and support for carbon credits and other offsets. In one non-limiting embodiment, there is provided a system to provide guided interfaces and support for users throughout the process of abandoning an oil or gas well, and to create and issue carbon credits corresponding to the abandonment of the oil or gas well upon completion of the project. In one non-limiting configuration, the system architecture is configured to ensure that carbon credits issued from the system are transparent and auditable, and that underlying support for the credits is accurate and supports the additionality and permanence of the project. In another or alternative non-limiting configuration, project information and/or documentation is stored on a public blockchain and/or distributed file system to ensure immutability and availability of the records. In another or alternative non-limiting configuration, carbon credits from a completed project are issued as tokens or other digital assets that may be exchanged between parties, and retired for reporting and emission offset purposes. In another or alternative non-limiting configuration, each token minted by the system links back to a specific project on the blockchain, allowing for public review of all supporting information and documentation.

In accordance with one non-limiting aspect of the present disclosure, there is provided a system for guiding and managing the process of producing high quality carbon credits that includes a) complete and accurate documentation of the conversion of project resources to a decommissioned resource, b) automated verification and/or user interfaces for manual verification of the quality of the information and documentation submitted for the quantification of the project, c) verification of proof of resource ownership or consent; verification of the additionality of claimed carbon volumes (e.g., by automated verification and/or providing interfaces showing a clear baseline of business-as-usual production forecast and associated emissions), and/or d) ongoing monitoring and verification of proof of permanence of abandoned reserves, through geological, petrophysical, and fluid property justification, as well as execution of monitoring activities and submission of regular reports over the course of the project life as well as contractual or regulatory determinations that preclude future production of oil and gas from the abandoned oil and gas reserves. In one non-limiting embodiment, there is provided producer-facing software tools and processes to guide a producer-user through the process of performing a credit producing activity, documenting the activity, and generating a high quality and well documented credit based on the activity. In another non-limiting embodiment, there is provided public-facing software tools, databases, and processes usable to verify the accuracy, additionality, permanence, and other aspects of provenance of high quality credits, such as utilizing decentralized, immutable, and auditable databases and record systems. In another non-limiting embodiment, there is provided equipment and sensors usable to aid in verifying permanence of underlying activity.

These and other advantages will become apparent to those skilled in the art upon reading and following the description taken together with the accompanying drawings.

### BRIEF DESCRIPTION OF THE DRAWINGS

Non-limiting and non-exhaustive embodiments are described with reference to the following drawings, wherein like labels refer to like parts throughout the various views unless otherwise specified. The sizes and relative positions of elements in the drawings are not necessarily drawn to scale. For example, the shapes of various elements are selected, enlarged, and positioned to improve drawing legibility. The particular shapes of the elements as drawn have been selected for ease of recognition in the drawings. Reference may now be made to the drawings, which illustrate various embodiments that the disclosure may take in physical form and in certain parts and arrangement of parts wherein:

FIG. 1 is a schematic diagram illustrating a decommissioned resource.

FIG. 2 is an architecture diagram illustrating aspects of a system for managing decommissioned resources.

FIG. 3 is a software architecture diagram illustrating aspects of a system for managing decommissioned resources.

FIG. 4 is a flowchart of a set of non-limiting steps that a system could perform to create a project.

FIG. 5 is a flowchart of a set of non-limiting steps that a system could perform to manage pre-abandonment aspects of a project.

FIG. 6 is a flowchart of a set of non-limiting steps that a system could perform to manage abandonment and permanence monitoring of a project.

FIG. 7 is a flowchart of a set of non-limiting steps that a system could perform to provide user interfaces for exchanging and retiring project tokens.

FIG. 8A is a schematic diagram of a decommissioned resource and a permanence module.

FIG. 8B is a schematic diagram illustrating non-limiting components of a permanence module.

FIG. 9A is a schematic diagram illustrating non-limiting components of a project page.

FIG. 9B is a schematic diagram illustrating non-limiting components of a project estimate interface.

FIG. 10 is a non-limiting schematic diagram illustrating data records and repositories for a system such as that of FIG. 2.

### DETAILED DESCRIPTION OF NON-LIMITING EMBODIMENTS

A more complete understanding of the articles/devices, processes and components disclosed herein can be obtained by reference to the accompanying drawings. These figures are merely schematic representations based on convenience and the ease of demonstrating the present disclosure, and are, therefore, not intended to indicate relative size and dimensions of the devices or components thereof and/or to define or limit the scope of the exemplary embodiments.

Although specific terms are used in the following description for the sake of clarity, these terms are intended to refer only to the particular structure of the embodiments selected for illustration in the drawings and are not intended to define or limit the scope of the disclosure. In the drawings and the following description below, it is to be understood that like numeric designations refer to components of like function.

The singular forms “a,” “an,” and “the” include plural referents unless the context clearly dictates otherwise.

As used in the specification and in the claims, the term “comprising” may include the embodiments “consisting of” and “consisting essentially of.” The terms “comprise(s),” “include(s),” “having,” “has,” “can,” “contain(s),” and variants thereof, as used herein, are intended to be open-ended transitional phrases, terms, or words that require the presence of the named ingredients/steps and permit the presence of other ingredients/steps. However, such description should be construed as also describing compositions or processes as “consisting of” and “consisting essentially of” the enumerated ingredients/steps, which allows the presence of only the named ingredients/steps, along with any unavoidable impurities that might result therefrom, and excludes other ingredients/steps.

Numerical values in the specification and claims of this application should be understood to include numerical values which are the same when reduced to the same number of significant figures and numerical values which differ from the stated value by less than the experimental error of conventional measurement technique of the type described in the present application to determine the value.

All ranges disclosed herein are inclusive of the recited endpoint and independently combinable (for example, the range of “from 2 grams to 10 grams” is inclusive of the endpoints, 2 grams and 10 grams, and all the intermediate values).

The terms “about” and “approximately” can be used to include any numerical value that can vary without changing the basic function of that value. When used with a range, “about” and “approximately” also disclose the range defined by the absolute values of the two endpoints, e.g., “about 2 to about 4” also discloses the range “from 2 to 4.” Generally, the terms “about” and “approximately” may refer to plus or minus 10% of the indicated number.

Percentages of elements should be assumed to be percent by weight of the stated element, unless expressly stated otherwise.

Although the operations of exemplary embodiments of the disclosed method may be described in a particular, sequential order for convenient presentation, it should be understood that disclosed embodiments can encompass an order of operations other than the particular, sequential order disclosed. For example, operations described sequentially may in some cases be rearranged or performed concurrently. Further, descriptions and disclosures provided in association with one particular embodiment are not limited to that embodiment, and may be applied to any embodiment disclosed.

For the sake of simplicity, the attached figures may not show the various ways (readily discernable, based on this disclosure, by one of ordinary skill in the art) in which the disclosed system, method and apparatus can be used in combination with other systems, methods and apparatuses. Additionally, the description sometimes uses terms such as “produce” and “provide” to describe the disclosed method. These terms are abstractions of the actual operations that can be performed. The actual operations that correspond to these terms can vary depending on the particular implementation and are, based on this disclosure, readily discernible by one of ordinary skill in the art.

The inventors have conceived of novel technology that, for the purpose of illustration, is disclosed herein as applied in the context of decommissioning and managing fossil fuel wells and/or other resources during the process of decommissioning the fossil fuel well and/or other resources. While the disclosed applications of the inventors' technology satisfy a long-felt but unmet need in the art of managing resources from the beginning to the end of decommissioning the resource, it should be understood that the inventors' technology is not limited to being implemented in the precise manners set forth herein, but could be implemented in other manners without undue experimentation by those of ordinary skill in the art in light of this disclosure. Accordingly, the examples set forth herein should be understood as being illustrative only, and should not be treated as limiting. The present disclosure is particularly directed to fossil fuels obtained from well and the issuance of carbon credits for the decommissioning of such wells, and will be described with particular reference herein. However, it will be appreciated that the present disclosure has broader applications to address credits (carbon credits or other types of credits) for any type of pollutant and/or greenhouse gas/emission. The system and method described herein can be equally applied to such other applications (e.g., closing a plant/factory/facility that burns fossil fuels, closing a plant/factory/facility that releases pollutants and/or toxic liquids and/or gasses, closing a farm or ranch to eliminate or reduce the number of livestock that is releasing gasses, etc.).

The voluntary carbon market is considered one of the best solutions to combat climate change, by bringing together key stakeholders and aligning economic incentives with the planet. Some important players in the voluntary carbon market are NGOs, project developers, verifiers, governments, companies and individuals. As an example, this may include a large general contractor or corporation planning a building or expansion project that adheres to a protocol developed by a voluntary carbon registry organization, and verifies the adherence of the project to the protocol throughout the process. Companies, individuals and governments looking to offset their emissions buy carbon credits through brokers that aggregate carbon credits. In some cases they will buy carbon credits from registries or, in rare exceptions, directly from project owners.

However, such voluntary markets face major challenges, both in regulation and technology, that are preventing those markets from scaling up quickly enough to meet market demand, and long-term goals, including low quality credits (e.g., credits whose origin and/or the underlying beneficial activity is questionable or unverifiable), low cost credits (e.g., low quality or falsified credits that are produced and sold quickly, at a relatively low cost, in the hopes of gaining the proceeds of a sale long before any issues of quality or fraud are detected), lack of supply (e.g., primarily lack of supply for high quality, reliable, auditable credits), and lack of transparency (e.g., low quality credits may be largely or entirely undocumented, or may issue from a voluntary registry/protocol that provides little documentation or verifiability, or that is otherwise not seen as trustworthy). As a result, such markets simultaneously face high demand, combined with readily available low quality and reliability credits, which has the potential to cause permanent or long term damage to the viability of such approaches (e.g., companies may purchase low quality and/or falsified credits without concern for the occurrence or permanence of the underlying activity, or companies may simply lose faith in the reliability of voluntary markets).

Characteristics of high quality carbon credits contribute to and ensure that they are accurate (e.g., the methodology used to determine the offset emissions is documented and accepted), additional (e.g., the beneficial activity was not simply a side-effect or result of ordinary business activity, such as a timber harvester replanting a harvested area, as shown by supporting documentation and information derived from detailed insight into the business and project), permanent (e.g., the beneficial activity was not temporary or reversible, such as a decommissioned oil or gas well that subsequently begins to leak emissions, or when a forest fire destroys forestry that was planted or maintained to produce a credit), and transparent (e.g., ready availability of complete, accurate, and permanent records of documentation, information, data, and other materials that support the accuracy, additionality, and permanence of the credit). Based on the above, an implementation of a system for guiding and managing the process of producing high quality credits should address some or all of the following: complete and accurate documentation of the conversion of project resources to a decommissioned resource; automated verification and/or user interfaces for manual verification of the quality of the information and documentation submitted for the quantification of the project; verification of proof of resource ownership or consent; verification of the additionality of claimed carbon volumes (e.g., by automated verification and/or providing interfaces showing a clear baseline of business-as-usual production forecast and associated emissions); ongoing monitoring and verification of proof of permanence of abandoned reserves, through geological, petrophysical, and fluid property justification, as well as execution of monitoring activities and submission of regular reports over the course of the project life as well as contractual or regulatory determinations that preclude future production of oil and gas from the abandoned oil and gas reserves.

Varying implementations of the disclosed technology address these and other concerns, and provide various other improvements to the technology and process of securing, maintaining, and transacting in credits, each as will be described in more detail in the figures and related descriptions below. More particularly, some implementations of the disclosed technology include producer-facing software tools and processes to guide a producer-user through the process of performing a credit producing activity, documenting the activity, and generating a high quality and well documented credit based on the activity. Some implementations of the disclosed technology include public-facing software tools, databases, and processes usable to verify the accuracy, additionality, permanence, and other aspects of provenance of high quality credits, such as utilizing decentralized, immutable, and auditable databases and record systems. Some implementations of the disclosed technology include equipment and sensors usable to aid in verifying permanence of underlying activity. These features and others described below may be implemented to provide substantial improvements to technology, and to the technical field of highly regulated, highly auditable record keeping, both specific to carbon credits and for similar or related purposes.

While the disclosed technology may be broadly implemented for various purposes, for the sake of clarity, discussions herein will relate the technology to the process of decommissioning fossil fuel resources such as oil and gas wells (e.g., shutting in hydrocarbons which otherwise would have been surfaced and produced as fossil fuels or other derivatives), and producing high quality carbon credits or other offsets based on such decommissioning.

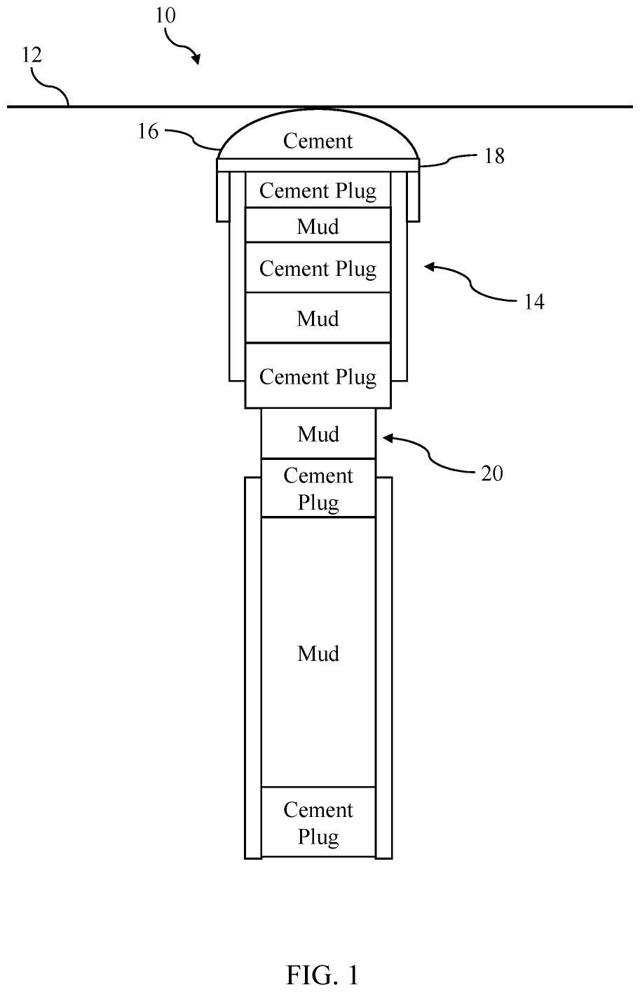

Turning now to the figures, FIG. 1 is a schematic diagram illustrating a decommissioned resource, more particularly, a decommissioned oil well (14). The well (14) is illustrated as a side profile, cross-sectional view that includes a ground surface (12) under which the well (14) is located at a site (10). While the scale, type, order, and number of layers for a decommissioned well will vary based on a particular scenario, the layers of the well (14) illustrated in FIG. 1 are exemplary, and include a cement cap (16), a steel plate (18), and a series of alternating layers (20) of cement and mud or other filler.

The plugging and abandonment (“P & A”) of oil and gas wells as illustrated in FIG. 1 is part of the normal operational life cycle, and is required to prevent any future contamination of groundwater or surface environment as a consequence of past extraction activities. In conventional approaches, once wells have been marked for permanent abandonment to prevent emission or pollution, plans for P & A must be submitted, permits issued, and approvals received from the respective regulating authorities. These must include detailed proposals for protecting subsurface groundwater resources connected to deeper contaminating zones via the wellbore, cleaning up any contamination at the surface around the wellhead, removing any surface equipment, and returning the well site to its natural state.

The P & A process provides an opportunity for operators to optionally also pursue carbon credits, which can create incentives to exchange their least efficient and most polluting hydrocarbon reserves for carbon credits, thus realizing the direct connection between the environmental impact, monetized by the price of carbon credits, and the price of oil and gas on the commodities market. However, as has been described, issues of complexity, lack of technology, and technical limitations make realization of these potential benefits impossible or unreasonable for many resource owners, and so many wells remain informally abandoned or unused without going through the P & A process. In such scenarios, a significant amount of detrimental and preventable emissions will occur.

The P & A process for gas or oil wells is well suited for implementation with the disclosed technology, as plugging a gas or oil well is irreversible (e.g., which simplifies some aspects of ensuring permanence and ongoing monitoring), and generates a substantial amount of information and documentation (e.g., which can be used as the basis for showing additionality, providing transparency, and otherwise ensuring aspects of credit quality). While reversal of P & A is not strictly impossible, the possibilities can largely be reduced to (i) accessing the abandoned resources via a different wellhead, or (ii) leakage of the wellhead after P & A, both of which are addressed by implementations of the disclosed technology, as will be described in more detail below.

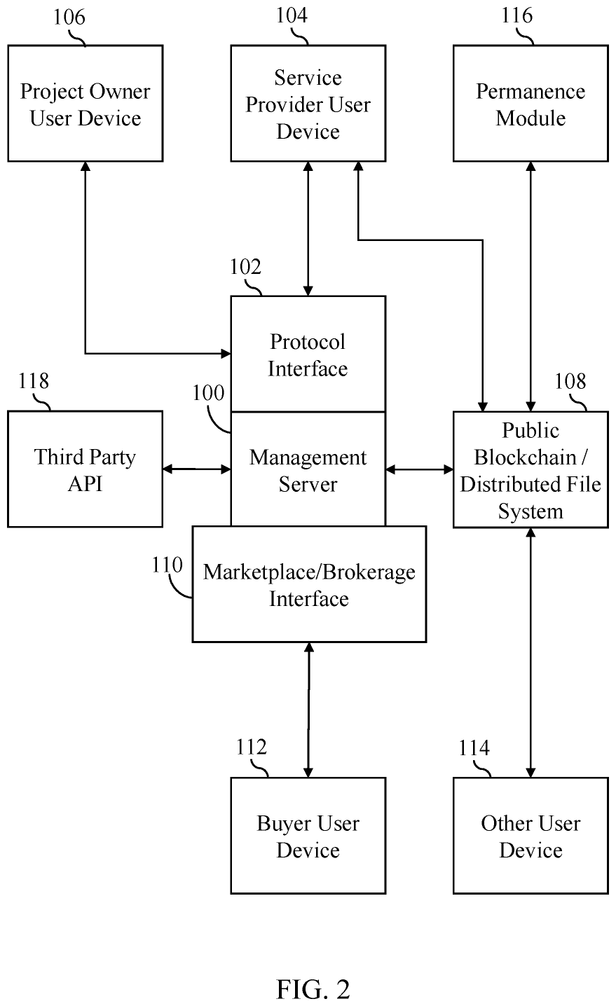

Turning now to FIG. 2, there is shown an architecture diagram illustrating non-limiting aspects of a system for managing decommissioned resources. A management server (100) is configured to provide a protocol interface (102) that is usable by a project owner (e.g., a well operator, which may be the actual land owner or an owner of the mineral or resource rights for the location, that wishes to decommission a natural resource) to facilitate the P & A process and simultaneously generate information and documentation supporting issuance of carbon credits, and a marketplace/brokerage (110) interface that is usable by a buyer to identify, review, and transact for carbon credits that are held by project owners and/or brokerages. The management server (100) is also configured to execute various logic and steps related to the interfaces (102, 110) as will be described in more detail below, which may include for example providing a guided user interface for submitting required information and/or completing certain steps of the process, automated validation and verification of submitted information and documentation (“Proof of Protocol”), automated monitoring for permanence (“Proof of Permanence”), and automated reporting and retirement of carbon credits.

Proof of Protocol may be used to describe the function and intent of the disclosed technology, where each process step and each official document involved in the process of verifying eligibility, completing P & A, and issuing carbon credits will be recorded or anchored to the blockchain or distributed file system (108). In practice it means that operators can go through a guided step-by-step process, upload relevant documents, link to external sources and get digital signatures from all official entities involved throughout the entire process, with such information and documentation being stored on the distributed file system (e.g., storing primarily discrete documents and files) and blockchain (108) (e.g., storing primarily text information but also descriptors, identifiers, and/or hashes of files stored on a distributed file system (108)), where it is immutable, verifiable, and not subject to permission or control by the management server (100) or any other system or entity. Proof of Permanence is similar to Proof of Protocol, but is focused on information, events, and documents subsequent to Proof of Protocol, such as ongoing monitoring and tracking of permanence for a decommissioned resource to ensure that there is no leakage, and that the resource is not reopened.

The management server (100) may be implemented as one or more cloud, virtual, physical, or other servers or server environments, and it should be understood that the management server (100) and other computer devices described herein may include one or more processors, memories, communication devices, storage devices, displays, user input devices, and other components as may be usable for receiving, analyzing, modifying, storing, and transmitting information, and performing other activities and steps as described herein.

The protocol interface (102) may be used by project owners via a project owner device (106) (e.g., a smartphone, tablet, computer, or other computing device) in order to initiate and self-manage their decommissioning project, and may also be used by service providers via a service provider device (104) (e.g., a smartphone, tablet, computer, or other computing device) during portions of the process that require independent inspection, action, or verification from a party other than the project owner. In each case, depending upon the state of the project and the type of user, the protocol interface (102) is configured to provide guided user interfaces that explain the required action or next step, require submission of related information and documents, and otherwise allow and facilitate the project owner and/or service provider to advance the project.

The marketplace/brokerage interface (112) may be used by buyers via a buyer user device (112) (e.g., a smartphone, tablet, computer, or other computing device) to search for carbon credits that are registered with the platform, review locations, descriptions, historical context, images, and/or other information associated with a decommissioned resource, purchase or otherwise transact for available carbon credits, review currently held carbon credits, and report and retire carbon credits when an offset for the buyer's other activities is desired. Operating in this manner, the marketplace/brokerage interface and other disclosed features may be implemented to provide an independent, verifiable and transparent system and method of identifying, capturing and recording co-benefits of qualifying activities, and with the non-fungible aspect of token credits allows a market based system to price in the value and impact of co-benefits. The interfaces (102, 112) may be implemented as browser based user interfaces, application based user interfaces and logic (e.g., desktop or mobile applications), web applications, application programming interfaces (“API(s)”), or combinations of the preceding and other communication interfaces. Additionally, the management server (100) may also be in communication with one or more third party APIs (118), which may include communication interfaces enabling communication with third party systems, data sources, and services, such as may be usable to complete or support activities performed by the management server. As an example, third party APIs (118) may include communication with third party systems for verifying ownership of property, verifying accuracy of records or other information submitted by users against publicly available records, retrieving publicly available records, and other activities.

The system of FIG. 2 also may include a public blockchain and distributed file system (108) that is used to provide immutable and decentralized storage of information and records evidencing carbon credit provenance and quality. In this manner, such information and records are advantageously transparent and publicly available, tamper proof (e.g., either due to impossibility, or due to any tampering being readily detectable and reversible due to the self-auditing nature of blockchains), and easily verifiable (e.g., any information available on the blockchain may be traced back to its introduction). While information may be written to the public blockchain (108) by the management server (100), such as records and documents submitted by a project owner or service provider via the protocol interface, and processed by the management server (100) before being written to the blockchain (108), information and records may also be written directly to the blockchain, bypassing the management server (100) entirely.

This type of data flow advantageously provides even more transparency and credibility for the affected data, and for example would prevent tampering or falsification of data by even the administrators or owners of the management server (100) itself. As one example, the protocol interface (102) may be a substantially or entirely client-side application executed by the service provider user device (104), and that facilitates writing of the information and records submitted by the service provider directly to the public blockchain (108), bypassing the management server (100), and the management server (100) may only be notified that the service provider has submitted information or records based upon monitoring of the blockchain (108) for new records. Such an architecture mitigates the possibility of, and user concerns for, tampering by the management server (100) itself (e.g., such as a suspicion or concern of a service provider that submitted information, which may negatively impact the project owner's ability to receive carbon credits, might be modified or obfuscated to mitigate the negative impact before being written to the blockchain (108)).

Other user devices (114) may also be used to access the public blockchain and distributed file system (108), which may include various computing devices configured to participate in the blockchain (108) (e.g., providing proof of work, auditing and/or verifying the blockchain records), whether or not the owners/users of those devices are using any other aspect or functionality of the system. As an example, any user of a device (114) may directly access the blockchain (108) to review information and records related to P & A and carbon credits issued for any resource, without being required to have a user account or session with the management server (100), and without being required to utilize the interfaces (102, 110).

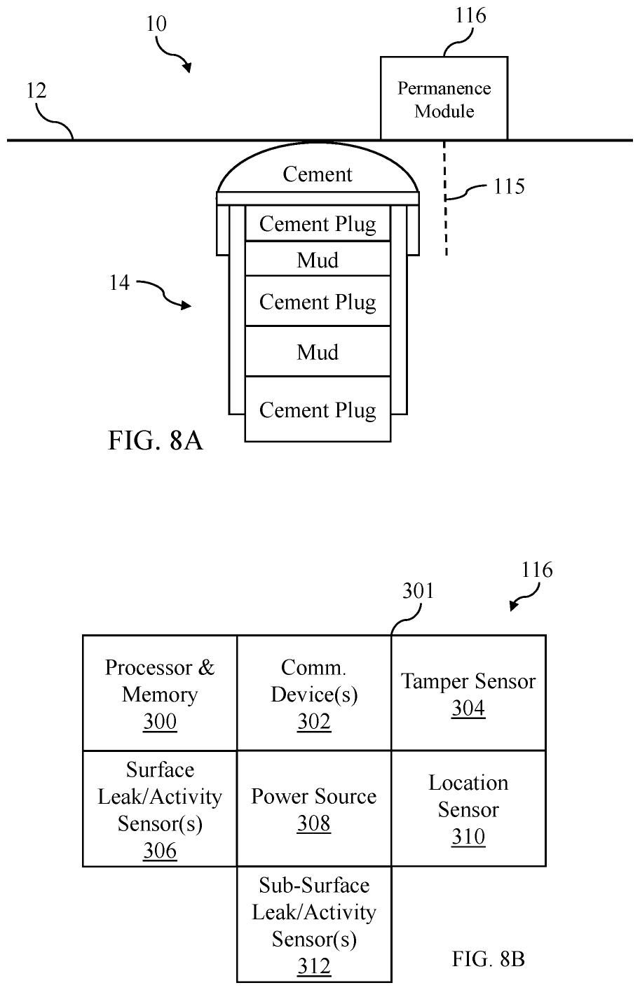

Referring now to FIG. 2, a permanence module (116) may be used that is in communication with the public blockchain (108). A permanence module may be installed and configured for a decommissioned resource in order to provide ongoing information and monitoring of the decommissioned resource, with such information being used to verify the permanence of abandonment of the resource for a desired period of time after completion of P & A and issuance of carbon credits. FIG. 8A shows the permanence module (116) installed at the site (10) illustrated by FIG. 1, with the module (116) located proximately to the surface (12) level portion of the well (14), and with a sensor probe (115) buried under the surface (12) to enable the use of ground-based sensors of the permanence module (116). As can be appreciated, the information from the permanence module can be supplemented with or be substituted by the use of periodic (e.g., daily inspections, weekly inspections, monthly inspections, quarterly inspections, semi-annual inspections, annual inspections, etc.) physical inspections (e.g., manual inspections, drone inspections, satellite inspections, robotic device inspections, etc.). Information from the period physical inspections, when used, can be manually entered and/or electronically transmitted to the Management Server and/or the public blockchain (108).

FIG. 8B shows a schematic diagram of a non-limiting permanence module, such as that shown in FIGS. 1 and 8A. The permanence module (116) may include a case (301) or housing that is weather resistant, impact resistant, heat resistant, and that includes other capabilities and structures to allow placement and use of the module (116) at the site (10) over extended periods of time (e.g., between about one year and about 20+ years, beginning after completion of P & A). An interior of the housing (301) may include one or more processors and memories (300), one or more communication devices (302) (e.g., wireless communication devices, such as a Wi-Fi, Bluetooth, or cellular network receiver, and wired communication devices, such as a USB, Ethernet, or other hardwired interface), a power source (308) (e.g., a hardwired electrical connection, batteries, solar panels, or a combination of the preceding), and components or circuitry for one or more components and/or sensors. Sensor capabilities of the permanence module (116) may vary by implementation, site, and resource, but for example may include a tamper sensor (304), a surface activity sensor (306), a location sensor (310), and/or a sub-surface activity sensor (312), which may be partially or wholly buried below the surface (12) (e.g., such as by the probe (115), which may be buried at a desired depth and coupled to the sub-surface sensor (312)). The one or more sensors can be used to detect and/or measure the concentration of one or more of methane, carbon dioxide, hydrogen, hydrogen sulfide, carbon monoxide, chlorine, cyanide, mercaptan, nitric oxides, nitrogen, sulfur oxides, ammonia, ammonium, and oxygen.

The tamper sensor (304), when used, may include motion sensors, force or impact sensors, heat sensors, water sensors, and/or other sensors that are configured to detect characteristics of the environment proximate to the permanence module (116) that may indicate an attempt to tamper with, damage, or remove the module (116). Sensor output, interpretation of sensor signals (e.g., such as concluding that someone has opened the housing (301) based on motion sensor data), and other information may be reported to the management server (100), written directly to the blockchain (108), or both. Such records may be used to identify, investigate, and resolve any questions or concerns about permanence of the decommissioned resource (e.g., such as an attempt by the project owner to relocate or disable the module (116) and/or recommission the resource for further use).

The surface activity (306) and/or sub-surface activity sensors (312), when used, may be configured to detect vibrations, gas emissions (e.g., such as from a leaking decommissioned resource), and other characteristics present in the soil, air, and other areas proximate to the well (114), and that may indicate a lack of permanence for the decommissioned resource (e.g., whether due to intentional efforts to reopen the resource, or due to flawed P & A or subsequent damage from weathering or other natural activity). As with prior examples, such information (e.g., signals, or local interpretation) may be reported to the management server (100), written directly to the blockchain (108), or both, and may be used to identify, investigate, and resolve any questions or concerns about permanence of the decommissioned resource. The location sensor (310), when used, may be, for example, a global positioning satellite receiver, LAN receiver, cell tower receiver, or other positioning device, and may be configured to report location information for the module (116) and, absent tampering or other activity, the location of the well (114) itself, in a similar manner and for similar purposes as those described above in relation to other sensors. The location sensor (310) can also be used to monitor unauthorized movement of the permanence module.

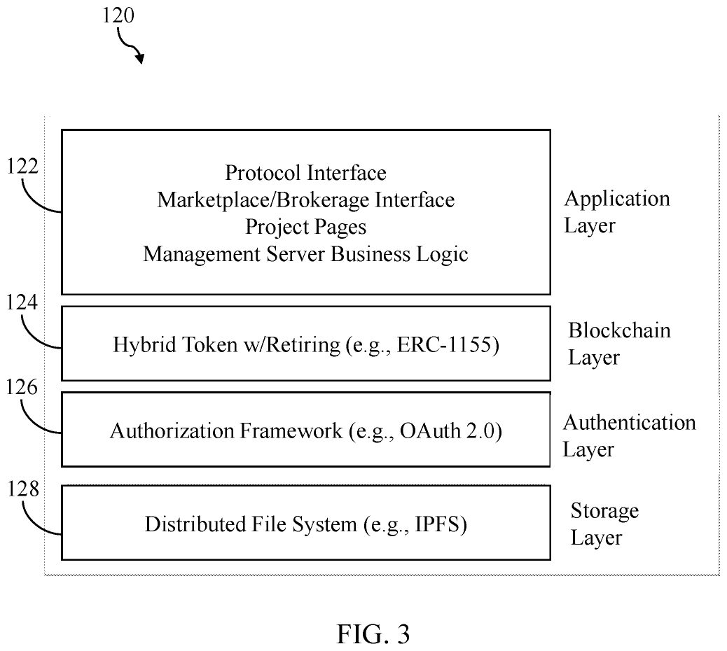

Turning now to FIG. 3, that figure illustrates a software architecture (120) that may be implemented for the system described above. An application layer (122) of the architecture (122) may be configured to include the protocol interface (102), marketplace/brokerage interface (110), project pages (e.g., web pages, application portals, or other web locations created and managed by the management server (100) to collect and document information from the public blockchain and distributed file system (108)), as well as various business logic and other programming configurations that are executed by the management server (100) in support of the above. A blockchain layer (124) of the architecture may be implemented using varying blockchains, token types, and tokens. Some implementations may advantageously utilize a hybrid token or multi-token as a digital asset that corresponds to an issued carbon credit (e.g., once all prerequisites of the carbon credit protocol have been completed and verified, the system may mint and issue a number of tokens that correspond to the number of carbon credits determined for the project).

A hybrid token supports both fungible and non-fungible aspects, which is useful since every token corresponds to one carbon credit (e.g., one carbon credit generally corresponds to one metric ton of prevented CO2e emissions) and may be pooled together by a holder, while the non-fungible aspect ensures that each token is traceable to a specific project even if separately pooled (e.g., a buyer using the marketplace/brokerage interface (110) may view pools of tokens, or may view each individual token more granularly in order to determine its source project, view supporting records and documentation, and so on). The hybrid token may also advantageously support retiring of the token, which may occur when the corresponding carbon credit is reported or applied to offset emissions, or when ongoing permanence monitoring determines that the carbon credit permanence is not verifiable (e.g., due to a subsequent leak or tampering), for example. In varying implementations, retirement of tokens may disable further transmission of the tokens (e.g., to prevent sales of already-consumed carbon credit), and may disable reporting or application of the tokens for emission offset purposes (e.g., to prevent double-reporting).

The architecture (120) also may include an authentication layer (126) that may be implemented using one or more authorization frameworks or other authorization and authentication packages. However, it should be noted the authentication layer (126) does not prevent direct access to the public blockchain and distributed file system (108), or require permissioned/authenticated access to the same, which advantageously prevents the owner or administrator of the management server (100) from becoming a centralized gatekeeper for information and records produced by the system, improving the transparency and accessibility of the system.

The architecture (120) also may include a storage layer (128) that may include a private database or file repository storage by the management server (100), but that also includes decentralized storage of files and large amounts of data in a distributed file system (e.g., such as the Interplanetary File System platform, or “IPFS”). Storage of large files and large amounts of data on public blockchains (108) is often not possible or not commercially viable (e.g., some popular blockchains limit the size of a written record to about 1 megabyte, which can easily be exceeded by common file types such as JPG images, word processor documents, PDF documents, and can also be easily exceeded by character or integer data in comma-separated-value or markup language format). Instead, large files and other datasets may be stored in the distributed file system, and records written to the blockchain (108) may reference those files or datasets where they are located on the distributed file system.

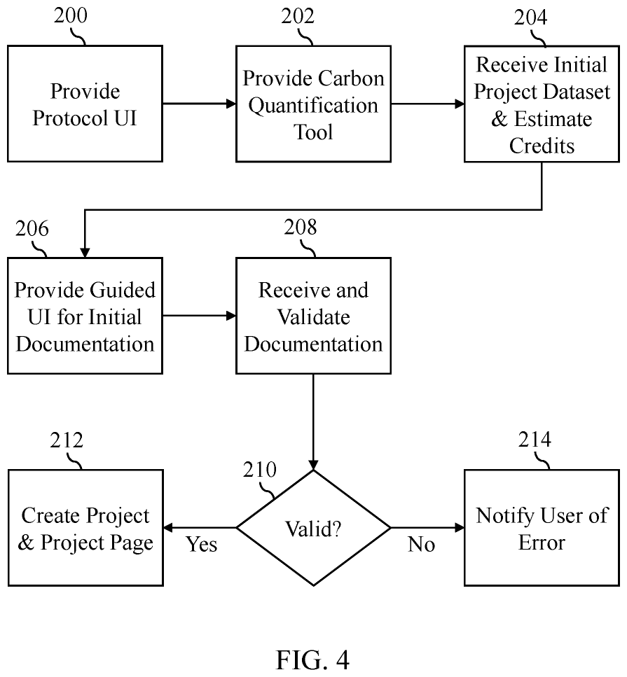

While a number of the features and functions of the disclosed technology have been described above, FIGS. 4-7 provide additional non-limiting examples and details of steps that may optionally be performed by the system to provide such features and functions. FIG. 4 is a flowchart of a set of steps that a system could perform to create a project on the platform. The system (e.g., the management server (100)) provides (200) the protocol interface (102) to the project owner device (106). The protocol interface (102) includes a carbon quantification tool (202) that prompts users to input information relating to their potential project, which may include, for example, the site location, resource type, well depth, remaining resource volume, and historical data, such as well age, past resource extraction, and other historic information and documentation relating to the resources past production, potential future production, and current state. This initial information is received as an initial project dataset, and is used to establish details such as the user's account and personal information, to generally determine the location of the project, and to provide a quantitative estimate (204) of carbon credits that would be issued to the project owner upon completion of the P & A.

While the initial quantitative carbon credit result is not relied upon as the basis for eventually issuing credits, the calculation and determination of the initial credit estimate and final credit issuance may be based upon the same or similar information, which is input by the project owner and/or third parties involved in the P & A process, as will be described in more detail below. As further explanation, the amount of CO2 emissions avoided through abandoning wells, which corresponds to the number of carbon credits issued, may be determined as a factor of the amount of reserves that are associated with the proposed project, and whether those reserves are recoverable and economically viable or effectively unusable. Economic viability of reserves may be based upon a number of sub-factors, such as cost of recovery, current or average commodity market value, industry standard pricing mechanisms, cost of additional equipment or improvements required for recovery, technical subsurface parameters, supply chain cost and availability, environmental, governmental, legal, and social factors, and other information. While the initial quantification of carbon credits may be based upon missing or incomplete information, determination of the final quantification, and corresponding issuance of carbon credits, by the management server (100) or another device of the system will require a complete set of information.

Additional or alternative approaches that may be used for initial or final quantification may include determination of a produced fluid characterization at a specified reference point in the production flow chain. The reference point is a defined location within a petroleum extraction and processing operation where the produced quantities are measured or assessed. A reference point is typically the point of sale to third parties or where custody is transferred to the midstream or downstream operations ultimately resulting in the combustion of the product and emission of the associated greenhouse gases by the end users of the refined products. Such assessments can account for non-sale quantities that are lost prior to that point, and so must be added to the sale-quantity to arrive at the full sum of avoided emissions for subsequent abandonment, and can also account for and deduct volume based on additives and other materials added after extraction or during processing, which are not counted as avoided emissions.

This performance-based analytical procedure for estimating recoverable quantities may be based upon material balance, history matched simulation, decline-curve analysis, and/or rate-transient analysis. Reservoir modeling or reservoir simulation can be considered a more rigorous form of material balance analysis. While such modeling can be a reliable predictor of reservoir behavior, the reliability of input rock properties, reservoir geometry, relative permeability functions, fluid properties, and constraints are very helpful. Predictive models are most reliable in estimating recoverable quantities when there is sufficient production history to validate the model through history matching.

Additional or alternative approaches that may be used for initial or final quantification may include an analysis of the change in production rate and production fluid ratios versus time and versus cumulative production as reservoir fluids are withdrawn. In some cases, before production decline rates become apparent, trends in performance indicators such as gas/oil ratio, water/oil ratio, condensate/gas ratio, and bottomhole or flowing pressures can be extrapolated to economic limit conditions to estimate reserves.

Initial or final quantification may also include calculation of carbon emission content of reserves based upon one or more approaches. Gas phase carbon content may be determined using the emission constant for Methane, 52.91 kg CO2/MMBtu, which constitutes the majority of the gas phase after the well site phase separation process. The emissions factor is adjusted by the heating factor, for pure Methane it is 1.00 MMBtu/Mscf and it can be higher to account for the presence of any heavier gas components such as Ethane, Propane, Butane, and Pentane+ in the gas phase. The factor can be determined by a historic or current gas analysis report.

In addition to the CO2 emissions offset by preventing the combustion of the reported gas reserves, there is also an assumed release of methane through system operations and through leaks during transportation to downstream market. This amount may be assumed to be about 2.3%; however, other percentages can be used. The CO2 equivalent greenhouse effect of Methane is 27.9 times greater than that of CO2, thus for purposes of carbon credits, 2.3% of the gas phase stream is evaluated at 1,322.75 kg CO2 equivalent/Mscf.

The CO2 emission factor of produced oil is highly variable due to the unique composition of all hydrocarbon deposits, which are dependent on the original organic source, depositional environment, depth, and time of subduction, as well as any subsequent erosion and reduction in burial depth resulting in potential weathering of deposits. However, the API gravity, a measure of the density of the oil phase, is closely correlated with length of its component carbon chains, namely the longer the carbon chains, the heavier the oil, the larger the CO2 emission factor upon processing and use. This measurement can also be determined based upon a historic or current oil analysis or sale receipt, which typically includes the API Gravity.

When determining the initial estimated carbon credits, as well as the final determination of issued credits, some or all of the described approaches may be used based upon the information and documentation available for the project, and provided by the project owner, service providers, or others. Several approaches may be separately calculated, and used in combination or context with each other in order to arrive at a blended approach to the determination. Additionally, the system (e.g., the management server (100)) may be configured with a machine learning or other artificial intelligence function, a pre-configured expert function, or another analytical function that is configured and/or trained to quantify carbon credits based on available information and/or a complete project dataset, and such determination may be used independently, or may be used in conjunction with other approaches as outlined above.

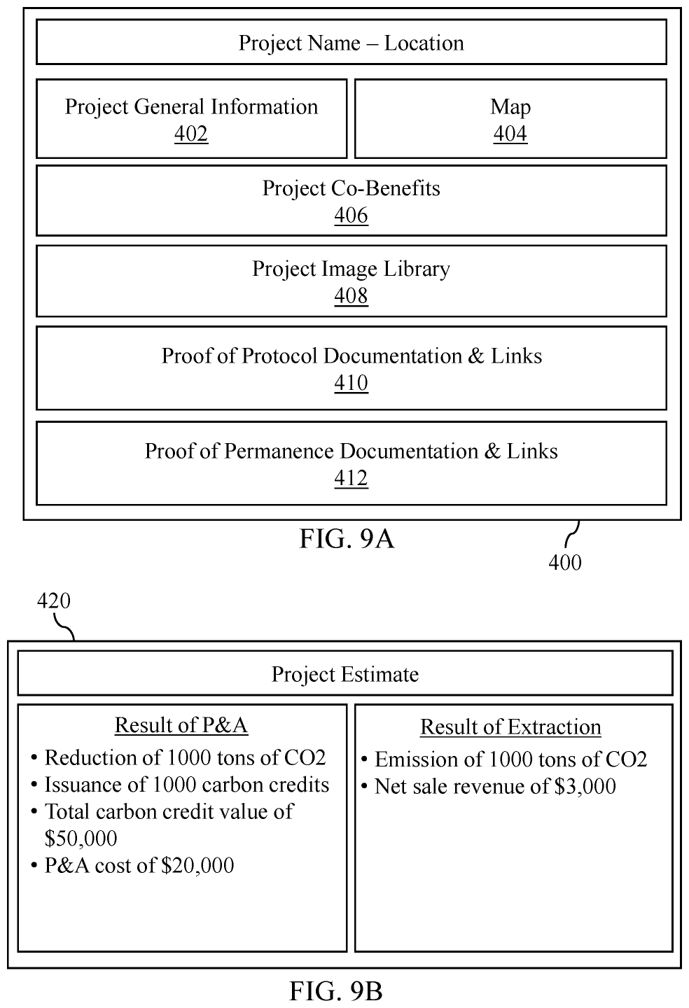

Returning now to FIG. 4 after estimating (204) the credits, the system may display to the user a summary of the estimate, which summary may include estimated value of the project (e.g., based upon estimated credits and current or average market value), and estimated commercial value of operating the resource for production and sale of reserves (e.g., this may be based upon information already received, and calculations already performed by the system in the process of determining commercial viability of the resource). FIG. 9B provides an example of a project estimate interface (420) that may be displayed to a user in relation to the above.

The system may also provide (206) a guided user interface for submitting additional documentation that is required to establish initial eligibility of the project for P & A and carbon credit issuance. The documentation received (208) through the guided UI (user interface) may include, for example, information and documentation evidencing the user's ownership of the location or site associated with the project, mutual consent of multiple owners or royalty recipients, boundaries, descriptions, or other information describing the location or site, including descriptions of the location or site in relation to other resources, and/or other information. This information and documentation may be provided as user input free-form text or menu selections, may be provided as a scanned or photographed images of documentations, may be provided via a third party API (118), and/or may be provided using combinations of the preceding and other similar means. In some implementations, consents from multiple owners or royalty recipients may be provided by click-acceptance or acknowledgment via the protocol interface (102), or via a mutual acceptance of the parties of a smart contract deployed to the blockchain (108) and associated with the new project. The system may also validate (208) the received documentation, which may include using a machine learning, artificial intelligence, preconfigured expert module, or other analytic function to automatically validate the information and documentation (e.g., including by comparison to validating information received via a third party API (118)), and/or may include providing a user interface to administrators of the management server (100) that are usable to review and validate the documentation, or both.

Where the information is not valid (210), the system may notify (214) the user of the error and provide an opportunity to address the error. As an example, where the user uploads a document that is purportedly evidence of legal ownership of the site, and a validation (208) of that document indicates that it is unrelated or insufficient to show legal ownership, the system may notify (214) the user with a description of the problem so that the user may submit additional or replacement documentation via the protocol interface (102). If the user is unable to provide documentation that is valid (210) for basic eligibility, the user's project is not created by the system, and does not proceed to any subsequent step or stage of the process, as will be described in more detail below.

Where the information is valid (210), the system may create (212) the project and corresponding project page. Creation (212) of the project may include creating one or more initial records for the project on the blockchain (108) and/or distributed file system describing information that has been provided for the project so far, and including links or references to supporting documentation (e.g., stored on the distributed file system). This may also include creation of records on a private or internal database that may reference or replicate information written to the blockchain, or that may include personal information of the project owner that is not published to the public blockchain (e.g., name, home address, birthdate, username, password, etc.).

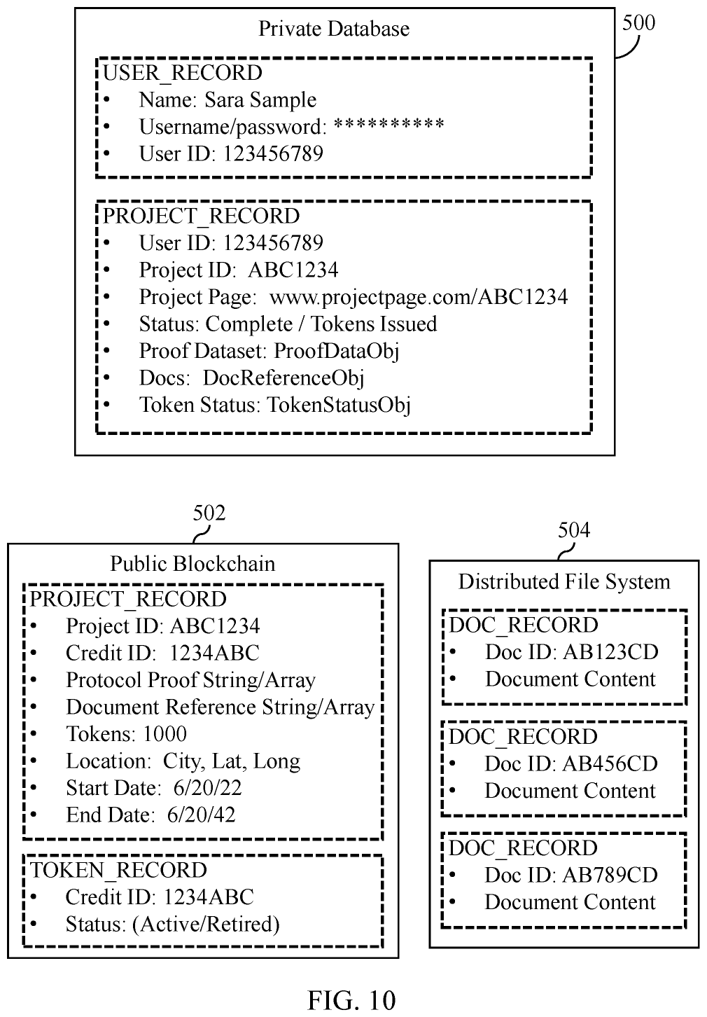

As further explanation, FIG. 10 provides a non-limiting example of distinct database or data repositories, the types of records and data written to each, and the relationship between records across distinct databases. As can be seen, records written to the private database (500) may include personal details of the user, and project details that are duplicate of or reference to information from the blockchain (108) (e.g., such as a “DocReferenceObj” that is a collection of identifiers and locations of documents stored on the distributed file system (504)), or that is irrelevant to the blockchain (108) (e.g., the URL for the project page associated with the project).

Records written to the public blockchain (502) may include project records (e.g., including unique project identifiers, unique carbon credit issuance identifiers, number of tokens issued and associated with project, project location, string or object descriptions of information and documentation supporting the project, and project dates during which the project and any resulting tokens are valid, as well as any fields required by the blockchain (108) such as hash values) and/or records related to tokens issued under the project (e.g., with a unique identifier linking each token or pool of tokens to the project record, and a status indicator that indicates whether the token is retired, as well as any required fields such as hash values).

Records written to the distributed file system (504) may include complete documents or files of various types, large datasets or container objects, related metadata (e.g., data formatted in a markup language such as XML, or a script markup such as JSONP), and basic document information (e.g., a unique document identifier that may be referenced by a project record and used to locate the document, or a project identifier or other information that relates the document record back to the project record).

Referring again to FIG. 4, creation (212) of the project page may include the management server (100) creating a unique web location, dashboard, portal, or other interface that serves as a collection of information for the project. While all of the relevant project information may be viewed or confirmed by accessing the blockchain (108) directly, the project page serves as a more user friendly, and more readily accessible collection of project information. FIG. 9A provides an example of the components and information that may be displayed on the project page (400) for a particular project, with such information and content being based upon the information available for the project in the public blockchain and distributed file system (108). The project page may be accessible to the project owner and other users of the system, and may be accessible by the buyer via the marketplace/brokerage interface (110) and usable to review the provenance and source of carbon credits prior to a transaction.

As illustrated in FIG. 9A, the project page (400) includes general information (402) on the project, such as a location, description, resource type, and other general information. As can be appreciated, the project page (400) can include other or additional information. A map (404) may also be included, which shows a map view of the project location, and that may include additional icons or other indicators that are relevant to the project. A project co-benefit pane (406) may be included, which provides information in text and graphic format showing various estimated benefits of the project (e.g., a measure of improvement in air quality near the site, a measure of pollution or emission reduction from the site, a measure of reduced road traffic or activity associated with the site, an estimate of additional reserves abandoned by the project but not factored into the calculation of token credits as a result of failing one or more qualification requirements, cost benefits for P & A, etc.). A project image library (408) may be included, which shows one or more images that have been provided for the site. Images may include photographs taken from the ground near the site, photographs of P & A equipment and modifications made to the site, satellite imagery of the site, or other images.

A Proof of Protocol Pane (410) may be included, which describes the status and basis for the project's satisfaction of the requirements of the protocol, and supports the quality and reliability of any corresponding credits. The Proof of Protocol Pane (410) may include text descriptions, embedded documents, links to related documents, and other information. As with other information displayed on the project page, the Proof of Protocol information and documentation is stored in the blockchain (108) and/or distributed file system, and so the pane (410) simply provides that information in a more condensed and more easily navigable format (e.g., a user may click on links for each supporting document to view them).

A Proof of Permanence Pane (412) may also be included, which describes the status of permanence for the site, and provides text descriptions, embedded documents, links, and other information that serve as the basis for permanence of the project. Similar to the Protocol pane (410) above, this information is essentially mirrored from the blockchain (108) and provided in a more user friendly and readily navigable format and interface. As permanence of the project is monitored and tracked over time (e.g., via regular manual inspection, or use of a permanence module (116)) the pane (412) will display additional information that is added to the blockchain (108), and so a potential buyer may inspect the pane (412) to determine how recently permanence was confirmed, and any other documentation or support for the conclusion of permanence. Similarly, where permanence for a project is not able to be confirmed, or is initially confirmed but later changes due to a leak, tampering, or other activity, the pane (412) will be updated to reflect the questionable permanence, as those records become available in the blockchain (108). Such additional information reflected by the pane may include a description and/or quantification of a leak, tampering, or other activity or situation (e.g., such as an estimated number of token credits that may now be unsupported by permanence of the project), a description or summary of actions taken by the platform in response to the unconfirmed permanence (e.g., identification of token credits that were invalidated as a result of the lack of confirmation, a description of token credits distributed from a buffer account or other pool to replace invalidated tokens, etc.), and other information.

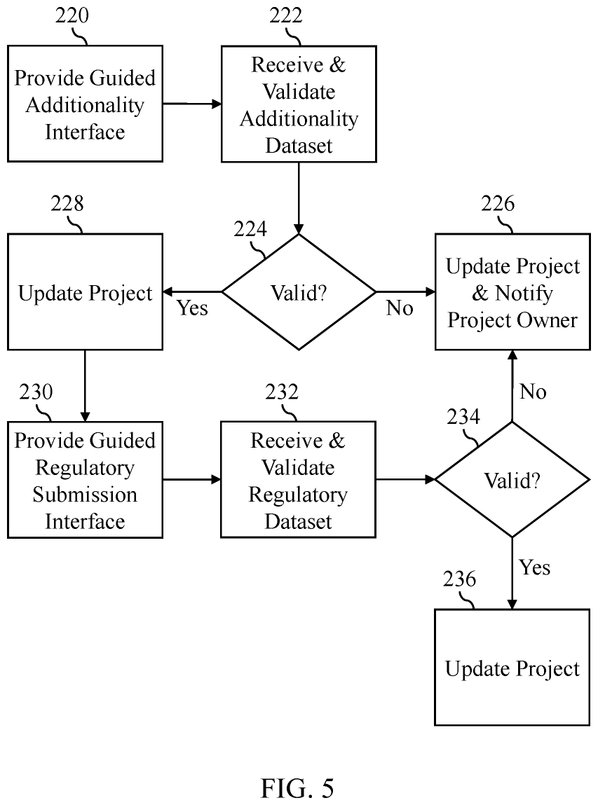

Turning now to FIG. 5, that figure shows a flowchart of a set of non-limiting steps that a system could perform to manage pre-abandonment aspects of a project. In some implementations, steps such as those of FIG. 5 may occur after basic eligibility requirements of a project are confirmed, and the project is created (e.g., such as described in the context of FIG. 4). The system may provide (220) a guided additionality interface via the protocol interface (102). The additionality interface may include information and descriptions related to additionality, prompts for certain information or documentation related to additionality, and features allowing a user of the interface to submit the required information to the management server (100) and/or directly to the blockchain or distributed file system (108).

In some implementations, the additionality interface may be made available to a project owner account, while in other implementations the additionality interface may instead be made available to an account other than the project owner account, such as an account on the platform associated with an independent analyst or auditor that will examine the documentation and information submitted for the project and then input additional information and documentation that provides an independent opinion on additionality, or that otherwise confirms or certifies additionality. Information received by the system via the guided additionality interface may be validated (222) by the system to determine whether additionality requirements for the project have been met. Such validation (222) may include manual review of documentation and information submitted by the project owner, an independent auditor, or both. Such validation (222) may also include automated review of such documentation and information by a machine learning, artificial intelligence, expert module, or other function configured or trained to assess additionality of a project based on information and documentation.

Where the system determines that additionality cannot be validated (224), the system may update the project (226) and notify the project owner of the lack of additionality, and may provide an opportunity for the project to update or correct information and documentation related to additionality. Updating (226) of the project after a failed validation of additionality may include writing records to the blockchain (108) to indicate the occurrence of the failure and provide descriptions of the failure, such as descriptions of and/or references to submitted additionality information on the blockchain and distributed file system (108). In this manner, a subsequent attempt by the project owner to validate additionality of the project may be successful, but the records and information related to any prior failed attempt are still accessible on the blockchain (108), and so may be assessed by a user of the platform when determining the overall provenance and quality of credits issued from the project.

Where the additionality dataset is received (222) and determined to be valid (224) (e.g., all of the required information has been submitted, and automated and/or manual review of the required information confirms any assessment of additionality), the system may update (228) the project to reflect that additionality requirements are met, with such project updates (228) being similar to other examples described above (e.g., underlying support for additionality and records of the validated additionality are written to the blockchain and distributed file system (108)).

The system may also provide (230) a guided regulatory submission interface. Similar to other guided interfaces described above, the regulatory submission interface may be provided to a project owner or other user of the system via the protocol interface (102), and may provide information and prompts specifying information and documentation that is required to perform P & A for the resource. This may include documents or information describing required permits, licenses, or other legal rights, proposals, estimates, or legal documents related to a contractor or other party that will perform the P & A, and other regulatory requirements related to preparing a resource for P & A, and initiating P & A activities. In addition to receiving documents and information via the guided regulatory interface (230), the system may also receive regulatory documents and information automatically via an interface or other communication channel with one or more databases or datasets of regulatory information, which may for example include publicly available databases provided by state or federal regulatory bodies.

As with prior examples, information and documentation received via the guided regulatory submission interface may be written directly or indirectly to the blockchain and distributed file system (108), and may be manually and/or automatically validated (232) for completeness and accuracy, and to ensure that all requirements of this step have been met. Manual validation (232) may include an independent service provider having an account on the platform using the protocol interface (102) to review and provide an assessment or certification of the regulatory submissions. Manual validation (232) may also or alternatively include the organization(s)/individual(s) that are maintaining the management server (100), protocol interface (102), regulatory submission interface, and/or marketplace/brokerage interface (110) to review and provide an assessment or certification of the regulatory submissions. Automatic validation (232) may include use of a machine learning, artificial intelligence, expert module, or other function configured or trained to assess the information and documentation submitted in the regulatory dataset to confirm that it is complete and accurate.

As with prior examples, where the regulatory dataset cannot be validated (234) for completeness and accuracy, the project may be updated (226) and the project owner may be notified of the failure, and provided an opportunity to update or correct the regulatory dataset. Similar to prior examples, updating (226) may include creating a record of the failed validation (234) on the blockchain (108), such that later assessment of the project will provide a complete picture of both successful and unsuccessful attempts to validate (232) the regulatory requirements. Where the regulatory dataset is successfully validated (234), the project may be updated (236) to reflect completion of the regulatory requirements, including writing records of the supporting information and documentation to the blockchain and distributed file system (108).

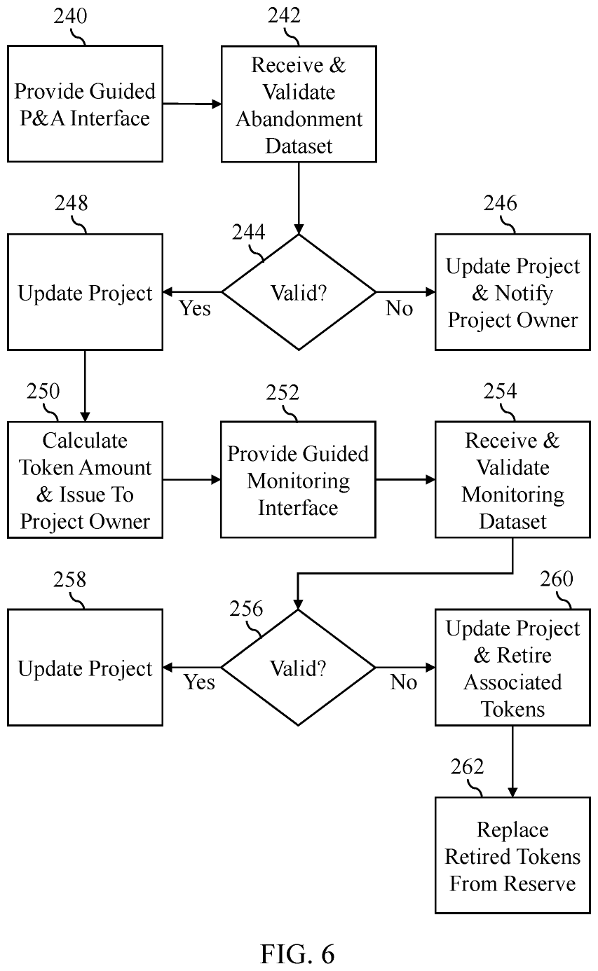

Turning now to FIG. 6, that figures shows a non-limiting flowchart of a set of steps that a system could perform to manage abandonment and permanence monitoring of a project. In some implementations, the steps of FIG. 6 may occur after additionality and regulatory requirements for the project have been documented on the blockchain (108) as complete, such as described in the context of FIG. 5. The system may provide (240) a guided P & A interface via the protocol interface (102) that is usable by a project owner to complete abandonment of the resource, and to submit information and documentation evidencing completion of the abandonment. In some implementations, this may include providing information to the project owner identifying service providers that can perform the P & A process (e.g., such as a contractor or other provider that can perform the plugging, capping, and other abandonment activities illustrated in FIG. 1). Information and documentation submitted as part of the abandonment dataset may include evidence of P & A initiation (e.g., invoices, work orders, or written communications from a service provider indicating that work has started, notification to regulatory authorities), evidence of P & A progress (e.g., invoices, status reports, or written communications evidencing current status or completion of milestones during P & A), and evidence of P & A completion (e.g., invoices, reports, or written communications evidencing full completion of the P & A project, which may include post-abandonment reports related to testing for leaks, performance of required site cleanup tasks, regulatory record of P & A completion, and other information).

As with prior examples, the received abandonment dataset may be written to the blockchain and distributed file system (108) and validated (242) manually, automatically, or both. In some implementations, validation (242) of the abandonment dataset may include review by an independent auditor or regulatory authority that is registered with the platform using the guided P & A interface to submit additional information and documentation assessing or certifying the P & A process. This information and documentation be provided via a third-party API as well, e.g. connecting to the regulatory database. In some implementations, validation (242) of the abandonment dataset may include use of a machine learning, artificial intelligence, expert module, or other function configured or trained to assess the information and documentation submitted in the abandonment dataset to confirm that it is complete and accurate. Where the abandonment dataset cannot be validated (244), the system update (246) the project and notify the project owner. As with past examples, failed validation of the abandonment dataset may be documented on the blockchain (108), such that a complete record of all past P & A and abandonment activity, whether successful or unsuccessful, may be assessed (e.g., by querying the blockchain (108) directly, and/or by accessing the project page (400) for the project).

Where the abandonment dataset is determined to be valid (244), the system may update the project (248) by writing records to the blockchain and distributed file system (108) reflecting that the resource associated with the project has been fully and successfully decommissioned, and that all regulatory and other requirements have been met as evidenced by the information and documentation submitted.

With the project updated (248) to reflect completion of P & A, the blockchain and distributed file system records (108) reflect a full chain-of-custody for the abandonment of eligible reserves, such that any carbon credit created from the eligible reserves can be traced to provide Proof-of-Protocol for the project. With an immutable, distributed, and transparent link to the Proof of Protocol for the project, the system may calculate (250) the final number of carbon credits that correspond to the reserves or prevented emissions for the decommissioned resource, and may issue those carbon credits to the project owner or other recipients. The calculation (250) of the amount of carbon credits is an automated process based on the submitted information and documentation at prior stages of the decommissioning process, and in some implementations the calculation and issuance of credits may be implemented as smart contracts that convert carbon content of eligible reserves (e.g., determined based upon one or more approaches to determining reserves, as has been previously described) into a corresponding number of carbon credits, and that issues those carbon credits to the project owner or other recipients.

In some implementations, issuance (250) of credits may include generating electronic documentation of certificates or documents describing the issued carbon credit(s), may include creating and minting tokens or other digital assets that each correspond to an issued carbon credit, or both (e.g., such as described in the context of FIGS. 3 and 10). Carbon credit tokens that are minted and issued (250) by the system may be held by the owner in a digital wallet, transmitted between digital wallets directly or as the result of transactions via the marketplace/brokerage interface (110), or reported as an emissions offset and retired by the user, as has been described.

In some implementations, tokens issued (250) by the system are programmable, and requirements and rules for showing Proof of Protocol are embedded in one or more smart contracts, leading to automated carbon credit creation and token minting once the requirements are met (e.g., a smart contract may query the blockchain (108) records for a project and make an objective determination that all requirements have been met, based upon prior submission and validation that have been performed and reflected on the blockchain (108)). Such smart contracts may be deployed to and executed by the blockchain (108), meaning that they are publicly viewable, and may be readily reviewed or verified by any interested party, further improving the transparency of the system, and the credits and tokens issued by the system.

When issuing (250) credits or tokens, the system may issue to one or several recipients. This may include sharing a number of issued tokens between the project owner and several other parties based on joint ownership or other shared interests in the decommissioned resource. This may also include setting aside a portion of the issued (250) tokens into a custodial digital wallet or token repository that is maintained by the administrators of the management server (100) (e.g., where 1000 tokens are minted upon completion of the project, 990 tokens may be issued to the project owner, and 10 tokens may be issued to a reserve pool or wallet that is not controlled by the project owner). The percentage maintained in the reserve pool or wallet is non-limiting (e.g., 0.1%-10% and all values and ranges therebetween). Maintaining a token reserve pool or buffer account in this manner advantageously provides a mechanism for replacing tokens that are minted by the system, and that are later retired due to a failure to show permanence of the project, as will be described in more detail below. As can be appreciated, there may optionally be a platform fee that can be based on a percentage of the minted tokens (e.g., 0.1%-10% of the minted tokens and all values and ranges therebetween), or can be some set value (e.g., 1-100 tokens and all values and ranges therebetween). The platform fee can be retained by the organization(s)/individual(s) that are maintaining the management server (100), protocol interface (102), regulatory submission interface, and/or marketplace/brokerage interface (110).

In some implementations, the system may be optionally configured to calculate (250) and issue tokens over a period of time that corresponds to ongoing monitoring and tracking of the project for permanence. As an example, where the system determines that 1000 carbon credits are generated by a project, the system may be configured to mint and issue tokens corresponding to those credits over a period of time instead of in a single batch. As further example, the system may mint and issue 200 tokens immediately upon completion (248) of the project, and then may mint and issue 200 additional tokens every 12 months thereafter until all 1000 tokens have been minted and issued. During the period of time over which tokens are minted and issued, the system is configured to perform and/or verify ongoing monitoring of the project for permanence (e.g., by way of regular manual inspection or use of a permanence module (116), with the results of such monitoring or inspection being added to the blockchain and distributed file system (108) as has been described). In this manner, where the project's permanence cannot be verified, the system may delay or cancel subsequent minting and issuance of tokens (e.g., if the abandoned resource begins leaking emissions after the issuance of 400 tokens, the system will not continue to mint and issue low-quality carbon credit and tokens for the project).

Once the project is completed (248), the system may optionally transition the project to a post-completion state in which the purpose of interfaces and automation is to publicly verify and support the permanence of the project over time. The system may optionally provide (252) a guided monitoring interface to the project owner or other users of the system (e.g., such as an independent auditor or inspector) while a project is in such a post-completion state. The guided monitoring interface may provide information and instructions related to ongoing permanence monitoring, and may be configured to receive information and documentation that supports the permanence of the abandonment. As the system receives information and documentation as a monitoring dataset, the system may write that information and documentation to the blockchain and distributed file system (108), and may validate (254) the monitoring dataset as described in previous examples (e.g., manual validation, automated validation, or both). Information submitted as part of the monitoring dataset may include, for example, independent inspection reports or assessments, photographic images captured at the site of the resource, output from sensors or other equipment (e.g., such as sensor data from a sensor of a permanence module (116)), and other information. In some implementations, the received (254) monitoring dataset may also optionally include electronic reporting and/or the results of automated searching for publicly available documents that might call into question the permanence of the project, such as well permits or operational licenses that might indicate that the resource has been returned to active use.

Where the monitoring dataset cannot be validated (256), the system may optionally update the project to reflect a lack of confirmation of permanence, and may also retire (260) some or all of the currently active carbon credits and corresponding tokens that are associated with the project. As an example, suppose a project owner receives 1000 token credits for completion of a project, and transfers 500 token credits to a recipient, and that recipient then reports 250 of the received token credits for emission offset purposes. In this example, there are still 750 active token credits, with the 250 inactive token credits having been retired and reported for offset purposes. Upon determining that permanence of the project cannot be confirmed (256), the system may immediately retire and make inactive the 500 token credits still held by the project owner, as well as the 250 token credits held by the recipient. As another example, of the above, rather than retiring all associated tokens, the system may instead make a determination and quantification of the impact on permanence, and may retire a proportional amount of tokens based on such a quantification (e.g., where a minor leak is detected but the emissions are still substantially prevented, 10% of the tokens or another amount may be retired). As has been described, retired token credits still exist and are visible upon inspection of the blockchain (108), but are configured to prevent any subsequent transfer between parties, and to prevent subsequent reporting for offset purposes.

In some implementations, the system may also optionally automatically replace (262) tokens that are retired (260) due to a lack of confirmation of permanence by transferring tokens from a reserve pool or other custodial wallet to any non-project owner holder of token credits retired in this manner. With reference to the preceding example, the project owner would not receive replacement token credits for the 500 token credits still held from their project, but the recipient and holder of the 250 retired tokens would receive replacement (262) tokens. Configured in this manner, the system may automatically monitor and ensure the permanence and related quality for carbon credits and tokens issued by the system, while ensuring that credits and tokens obtained through the system for offset purposes are reliable (e.g., involuntarily retired tokens may be automatically replaced by active tokens held in a reserve pool or other repository, as has been described).

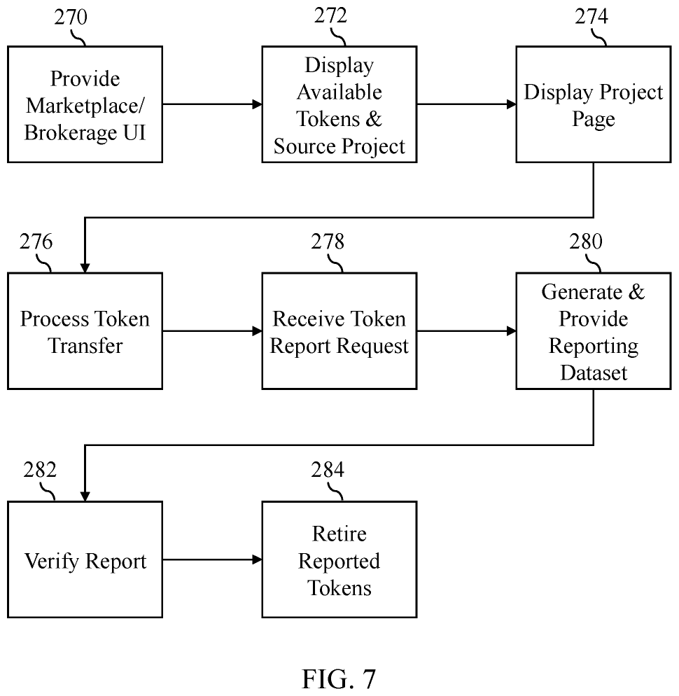

Turning now to FIG. 7, that figure shows a non-limiting flowchart of a set of steps that a system could perform to provide user interfaces for exchanging and retiring project tokens. The system may provide (270) the marketplace/brokerage interface (110) to users that seek to transfer currently held token credits to others, and users that seek to obtain token credits (e.g., either to hold those credits, or to report and retire the credits for emission offset purposes). The marketplace/brokerage interface (110) may display (272) lists of token credits that are available, and may provide tools and navigation options to allow users to identify and review the source project from which the token credits were issued. This may include displaying (274) the project page (400) and other information for the source project, as has been described. In this manner, a user seeking to obtain token credits for emission offset purposes may fully review the underlying support and documentation for Proof of Protocol and Proof of Permanence, as has been described. The marketplace/brokerage interface (110) may also be configured to effect the transfer of tokens between users (e.g., as a user initiated transfer, or as part of a completed purchase transaction conducted through the marketplace and/or brokerage).

The marketplace/brokerage interface (110) may also be usable by a current holder of token credits to facilitate reporting of the token credit for emission offset purposes. In such implementations, the system may receive (278) a token report request from a user of the system specifying a number of token credits held by the user, and including other information related to reporting carbon credits (e.g., the purpose, location, or business activity for which the credits are being reported). Based on the received (278) request, the system may generate (280) and provide a reporting dataset to the requester, which may include information and documentation evidencing the reported credits. In some implementations, the reporting dataset may include automatically generated documents that reflect the reported credits, and that are intended to be filed with a governmental body or other organization in order to officially report the credits for offset purposes. In some implementations, the reporting dataset may be automatically reported (e.g., via a third party API (118)) to a governmental body or other organization to officially report the credits for offset purposes. In some implementations, the reporting dataset is written to the blockchain and distributed file system (108).

In implementations where the system is not able to directly verify that credits have been reported (e.g., such as where the system generates and provides reporting documents to the requester, but relies upon the requester to submit those reports for offset purposes), the system may be configured to monitor and verify (282) that the report was officially submitted or accepted. Such monitoring and verification (282) may include automatically monitoring publications that reflect credits that are reported or claimed by companies (e.g., via content-scraping or other automated web content scanning means), or monitoring for reporting of the credits via a third party API (118) or other interface. In some implementations, the system may also rely upon input from the holder of the token credits to verify (282) that they have been reported.

Once reported, the system may then retire (284) the affected token credits, in order to prevent further transmission or use (e.g., double-reporting, fraudulent sales, etc.) of retired and exhausted token credits. Retired tokens remain visible on the blockchain (108) for later review and/or audit purposes, and where a holder of a retired token is using a digital wallet, or has otherwise configured the token or token repository to make the token private or invisible, retirement (284) of the token will cause it to become visible and publicly viewable via the blockchain (108).

It should be understood that any one or more of the teachings, expressions, embodiments, examples, etc. described herein may be combined with any one or more of the other teachings, expressions, embodiments, examples, etc. that are described herein. The following-described teachings, expressions, embodiments, examples, etc. should therefore not be viewed in isolation relative to each other. Various suitable ways in which the teachings herein may be combined will be readily apparent to those of ordinary skill in the art in view of the teachings herein. Such modifications and variations are intended to be included within the scope of the claims.

It will thus be seen that the objects set forth above, among those made apparent from the preceding description, are efficiently attained, and since certain changes may be made in the constructions set forth without departing from the spirit and scope of the disclosure, it is intended that all matter contained in the above description and shown in the accompanying drawings shall be interpreted as illustrative and not in a limiting sense. The disclosure has been described with reference to preferred and alternate embodiments. Modifications and alterations will become apparent to those skilled in the art upon reading and understanding the detailed discussion of the disclosure provided herein. This disclosure is intended to include all such modifications and alterations insofar as they come within the scope of the present disclosure. It is also to be understood that the following claims are intended to cover all of the generic and specific features of the disclosure herein described and all statements of the scope of the disclosure, which, as a matter of language, might be said to fall therebetween.

To aid the Patent Office and any readers of this application and any resulting patent in interpreting the claims appended hereto, applicants do not intend any of the appended claims or claim elements to invoke 35 U.S.C. 112(f) unless the words “means for” or “step for” are explicitly used in the particular claim.

What is claimed:

1. A system that is configured to support for a project owner through a process of abandoning an oil or gas well, and to create and issue carbon credits corresponding to the abandonment upon completion of an abandonment project; said system comprises:
a. a management server; said management server is configured to i) provide a protocol interface that is usable by said project owner to facilitate a plugging and abandonment process of the oil or gas well, and/or ii) generate information and/or documentation supporting issuance of carbon credits;
b. a marketplace/brokerage interface that is usable by a buyer to identify, review, and/or transact for carbon credits that are held by said project owner;
c. a public blockchain and distributed file system that is configured to provide immutable and/or decentralized storage of information and/or records evidencing carbon credit provenance and/or quality; and
d. a permanence arrangement; said permanence arrangement is configured to be in direct or periodic communication with said public blockchain and distributed file system and/or said management server; said permanence arrangement is configured to obtain information about the status of said abandoned oil or gas well and/or to monitor of said abandoned oil or gas well.

2. The system as defined in claim 1, wherein said management server is further configured to i) provide a guided user interface for submitting required information and/or completing certain steps of said process of abandoning the oil or gas well, ii) provide automated validation and/or verification of submitted information and documentation, iii) provide automated monitoring for permanence of said abandonment of said oil or gas well based on information received from said permanence arrangement, and/or iv) provide automated reporting and/or retirement of said issued carbon credits.

3. The system as defined in claim 2, wherein said management server is configured to provide automated monitoring for permanence of said abandonment of said oil or gas well; said monitoring for permanence of said abandonment of said oil or gas well includes periodic or continued monitoring and/or tracking of permanence of said abandonment of said oil or gas well so as to ensure that there is no leakage of carbon containing material from said abandoned oil or gas well and/or to ensure that said abandoned oil or gas well has not be restarted to produce carbon containing material.

4. The system as defined in claim 1, wherein said protocol interface can be configured for use by i) said project owner via a project owner device in order to initiate and self-manage the decommissioning process of said abandoned oil or gas well, and/or ii) a service provider via a service provider device during portions of said decommissioning process of said abandoned oil or gas well that require independent inspection, action, and/or verification from a party other than said project owner; said protocol interface is configured to provide guided user interfaces that a) explain a required action or next step, and/or b) requires submission of related information and documents so as to assist said project owner and/or said service provider during said decommissioning process of said abandoned oil or gas well.

5. The system as defined in claim 3, wherein said protocol interface can be configured for use by i) said project owner via a project owner device in order to initiate and self-manage the decommissioning process of said abandoned oil or gas well, and/or ii) a service provider via a service provider device during portions of said decommissioning process of said abandoned oil or gas well that require independent inspection, action, and/or verification from a party other than said project owner; said protocol interface is configured to provide guided user interfaces that a) explain a required action or next step, and/or b) requires submission of related information and documents so as to assist said project owner and/or said service provider during said decommissioning process of said abandoned oil or gas well.

6. The system as defined in claim 1, wherein said marketplace/brokerage interface is configured to be used by said buyer via a buyer user device to a) search for said carbon credits that are registered to said project owner, b) review locations, descriptions, historical context, images, and/or other information associated with said abandoned oil or gas well, c) purchase or otherwise transact for carbon credits that are available for purchase, d) review currently held carbon credits, and/or e) report and retire carbon credits when an offset for said buyer's other activities is desired.

7. The system as defined in claim 5, wherein said marketplace/brokerage interface is configured to be used by said buyer via a buyer user device to a) search for said carbon credits that are registered to said project owner, b) review locations, descriptions, historical context, images, and/or other information associated with said abandoned oil or gas well, c) purchase or otherwise transact for carbon credits that are available for purchase, d) review currently held carbon credits, and/or e) report and retire carbon credits when an offset for said buyer's other activities is desired.

8. The system as defined in claim 1, wherein information provided to said blockchain and distributed file system is provided by a) said management server, b) said project owner via said project owner device without first passing through said management server, and/or c) other user devices such as computing devices configured provide proof of work, auditing and/or verifying the blockchain records.

9. The system as defined in claim 7, wherein information provided to said blockchain and distributed file system is provided by a) said management server, b) said project owner via said project owner device without first passing through said management server, and/or c) other user devices such as computing devices configured provide proof of work, auditing and/or verifying the blockchain records.

10. The system as defined in claim 1, wherein said permanence arrangement includes collection of information of said abandoned oil or gas well by i) a permanence module that is at least partially installed at or near said abandoned oil or gas well, and wherein said permanence module includes two or more of a) a sensor arrangement, b) communication device, c) one or more processors and memories, d) a housing, e) position/location device, and/or f) a power source, and/or ii) periodic inspections of said abandoned oil or gas well by a person, a drone, an aircraft or other vehicle, a robotic device and/or satellite.

11. The system as defined in claim 9, wherein said permanence arrangement includes collection of information of said abandoned oil or gas well by i) a permanence module that is at least partially installed at or near said abandoned oil or gas well, and wherein said permanence module includes two or more of a) a sensor arrangement, b) communication device, c) one or more processors and memories, d) a housing, e) position/location device, and/or f) a power source, and/or ii) periodic inspections of said abandoned oil or gas well by a person, a drone, an aircraft or other vehicle, a robotic device and/or satellite.

12. The system as defined in claim 10, wherein said permanence arrangement includes said permanence module; said permanence module includes a tamper sensor and one or more chemical sensors; said one or more chemical sensors configured to detect and/or measure one or more of methane, carbon dioxide, hydrogen, hydrogen sulfide, carbon monoxide, chlorine, cyanide, mercaptan, nitric oxides, nitrogen, sulfur oxides, ammonia, ammonium, and oxygen.

13. The system as defined in claim 11, wherein said permanence arrangement includes said permanence module; said permanence module includes a tamper sensor and one or more chemical sensors; said one or more chemical sensors configured to detect and/or measure one or more of methane, carbon dioxide, hydrogen, hydrogen sulfide, carbon monoxide, chlorine, cyanide, mercaptan, nitric oxides, nitrogen, sulfur oxides, ammonia, ammonium, and oxygen.

14. The system as defined in claim 1, further including a software architecture; said software architecture incudes a) an application layer that is configured to include i) said protocol interface, ii) said marketplace/brokerage interface, iii) project page that include one or more web pages, application portals, or other web locations created and managed by said management server to collect and document information from said public blockchain and distributed file system, and iv) business logic and programming configuration that are executed by said management server, b) a blockchain layer that is implemented using blockchains, token types, and tokens, c) an authentication layer that is implemented using one or more authorization frameworks or other authorization and authentication packages, and wherein said authentication layer does not prevent direct access to said public blockchain and distributed file system, or require permissioned/authenticated access to said public blockchain and distributed file system, and/or d) a storage layer can includes a private database or file repository storage by said management server and/or a decentralized storage of files and large amounts of data in a distributed file system.

15. The system as defined in claim 13, further including a software architecture; said software architecture incudes a) an application layer that is configured to include i) said protocol interface, ii) said marketplace/brokerage interface, iii) project page that include one or more web pages, application portals, or other web locations created and managed by said management server to collect and document information from said public blockchain and distributed file system, and iv) business logic and programming configuration that are executed by said management server, b) a blockchain layer that is implemented using blockchains, token types, and tokens, c) an authentication layer that is implemented using one or more authorization frameworks or other authorization and authentication packages, and wherein said authentication layer does not prevent direct access to said public blockchain and distributed file system, or require permissioned/authenticated access to said public blockchain and distributed file system, and/or d) a storage layer can includes a private database or file repository storage by said management server and/or a decentralized storage of files and large amounts of data in a distributed file system.

16. The system as defined in claim 1, wherein said protocol interface includes a carbon quantification tool that is configured to that prompt said project owner to input information relating to site location, resource type, well depth, remaining resource volume, and/or historical data relating to the oil or gas well; said carbon qualification tool is used to provide a quantitative estimate of carbon credits that would be issued to said project owner upon completion of said abandonment project.

17. The system as defined in claim 15, wherein said protocol interface includes a carbon quantification tool that is configured to that prompt said project owner to input information relating to site location, resource type, well depth, remaining resource volume, and/or historical data relating to the oil or gas well; said carbon qualification tool is used to provide a quantitative estimate of carbon credits that would be issued to said project owner upon completion of said abandonment project.

18. The system as defined in claim 16, wherein system provides said project owner a summary that includes a) an estimated value of said abandonment project that is at least partially based on i) estimated carbon credits and current or average market value of such carbon credits and ii) estimated cost of abandoning said oil or gas well, and b) an estimated commercial value of operating said oil or gas well for production and sale of reserves.

19. The system as defined in claim 17, wherein system provides said project owner a summary that includes a) an estimated value of said abandonment project that is at least partially based on i) estimated carbon credits and current or average market value of such carbon credits and ii) estimated cost of abandoning said oil or gas well, and b) an estimated commercial value of operating said oil or gas well for production and sale of reserves.

20. The system as defined in claim 1, where said management server is configured to create a unique web location, dashboard, portal, or other interface that serves as a collection of information for said abandonment project.

21. The system as defined in claim 19, where said management server is configured to create a unique web location, dashboard, portal, or other interface that serves as a collection of information for said abandonment project.

22. The system as defined in claim 14, wherein said project page includes one or more types of information selected from a) general information on said abandonment project such as a location, description of oil or gas well, a map of oil or gas well, and/or a resource type, b) a project co-benefit pane which provides information showing various estimated benefits of said abandonment product such as a measure of improvement in air quality near the site, a measure of pollution or emission reduction from the site, a measure of reduced road traffic or activity associated with the site, an estimate of additional reserves abandoned by the project but not factored into the calculation of token credits as a result of failing one or more qualification requirements, and/or cost benefits for abandoning said oil or gas well, c) a project image library that includes one or more images of the site of said oil or gas well, d) a Proof of Protocol Pane that includes information on a status of abandonment product and/or provides support for a quality and quantity of carbon credits associated with the abandonment product, and/or e) a Proof of Permanence Pane that includes information regarding a status of permanence for said oil or gas well.

23. The system as defined in claim 21, wherein said project page includes one or more types of information selected from a) general information on said abandonment project such as a location, description of oil or gas well, a map of oil or gas well, and/or a resource type, b) a project co-benefit pane which provides information showing various estimated benefits of said abandonment product such as a measure of improvement in air quality near the site, a measure of pollution or emission reduction from the site, a measure of reduced road traffic or activity associated with the site, an estimate of additional reserves abandoned by the project but not factored into the calculation of token credits as a result of failing one or more qualification requirements, and/or cost benefits for abandoning said oil or gas well, c) a project image library that includes one or more images of the site of said oil or gas well, d) a Proof of Protocol Pane that includes information on a status of abandonment product and/or provides support for a quality and quantity of carbon credits associated with the abandonment product, and/or e) a Proof of Permanence Pane that includes information regarding a status of permanence for said oil or gas well.

24. The system as defined in claim 1, further including an additionality interface that allows a project owner to submit information to said management server and/or directly to said blockchain or distributed file system; said additionality interface is configured to allow a third party to access information submitted by said project owner so that such information can be analyzed, reviewed, validated and/or approved by said third party; said additionality interface is configured to provide information to said project owner as to whether said submitted information has been rejected or approved; said submitted information and said rejection or approval of said submitted information is saved in said blockchain and distributed file system.

25. The system as defined in claim 23, further including an additionality interface that allows a project owner to submit information to said management server and/or directly to said blockchain or distributed file system; said additionality interface is configured to allow a third party to access information submitted by said project owner so that such information can be analyzed, reviewed, validated and/or approved by said third party; said additionality interface is configured to provide information to said project owner as to whether said submitted information has been rejected or approved; said submitted information and said rejection or approval of said submitted information is saved in said blockchain and distributed file system.

26. The system as defined in claim 1, further including a regulatory submission interface; said regulatory submission interface provides information to said project owner regarding one or more of required permits, licenses, legal rights, proposals, estimates, and/or legal documents related to a) a contractor or other party that will perform plugging and abandonment of said oil and gas well, b) a regulatory agency, and/or c) an initiation of plugging and abandonment of said oil and gas well; information and documentation received via said regulatory submission interface is i) saved in said blockchain and distributed file system, and/or ii) validated for completeness and accuracy, and to ensure that all regulatory requirements are met.

27. The system as defined in claim 25, further including a regulatory submission interface; said regulatory submission interface provides information to said project owner regarding one or more of required permits, licenses, legal rights, proposals, estimates, and/or legal documents related to a) a contractor or other party that will perform plugging and abandonment of said oil and gas well, b) a regulatory agency, and/or c) an initiation of plugging and abandonment of said oil and gas well; information and documentation received via said regulatory submission interface is i) saved in said blockchain and distributed file system, and/or ii) validated for completeness and accuracy, and to ensure that all regulatory requirements are met.

28. The system as defined in claim 1, further including abandonment and permanence monitoring arrangement usable by said project owner to complete a process for plugging and abandonment of said oil and gas well, and to submit information and documentation evidencing completion of plugging and abandonment of said oil and gas well; said information submitted by said project owner related to said process for plugging and abandonment of said oil and gas well is saved on said blockchain and distributed file system; said information submitted by said project owner related to said process for plugging and abandonment of said oil and gas well is manually validated and/or validated by an automated system.

29. The system as defined in claim 27, further including abandonment and permanence monitoring arrangement usable by said project owner to complete a process for plugging and abandonment of said oil and gas well, and to submit information and documentation evidencing completion of plugging and abandonment of said oil and gas well; said information submitted by said project owner related to said process for plugging and abandonment of said oil and gas well is saved on said blockchain and distributed file system; said information submitted by said project owner related to said process for plugging and abandonment of said oil and gas well is manually validated and/or validated by an automated system.

30. The system as defined in claim 1, wherein said system issues or creates electronic documentation of certificates or documents describing issued carbon credits.

31. The system as defined in claim 29, wherein said system issues or creates electronic documentation of certificates or documents describing issued carbon credits.

32. The system as defined in claim 30, wherein said issued carbon credits are programmable, and requirements and rules for showing Proof of Protocol are embedded in one or more smart contracts, leading to automated carbon credit creation and token minting once the requirements are met.

33. The system as defined in claim 31, wherein said issued carbon credits are programmable, and requirements and rules for showing Proof of Protocol are embedded in one or more smart contracts, leading to automated carbon credit creation and token minting once the requirements are met.
